(19) United States
(12) Patent Application Publication
(10) Pub. No.: US 2007/0216928 A1
(43) Pub. Date: Sep. 20, 2007

(54) Driver program, printing apparatus control method and printing control apparatus

(75) Inventor: Masahiko Hirasawa, Nagano-Ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/724,878

(22) Filed: Mar. 15, 2007

(30) Foreign Application Priority Data
Mar. 15, 2006 (JP) 2006-071740

(51) Int. Cl. G06F 3/12

(52) U.S. Cl. 358/1.13

(57) ABSTRACT

There is provided a driver program for controlling a printing apparatus. The driver program causes a computer to perform operations of obtaining one or more pieces of image data of one or more virtual pages from an image processing application, where the pieces of image data are in a one-to-one correspondence with the virtual pages, receiving, from an external device, at least one of (i) a predetermined number M indicating the number of regions obtained by dividing each of print pages to be printed by the printing apparatus and (ii) an allocation number N indicating the number of regions in the each of the print pages to which the pieces of image data are allocated, receiving, from an external device, a repetition number indicating the number of times at which the pieces of image data are repeatedly allocated to the print pages, dividing the each of the print pages into M regions based on the at least one of the predetermined number M and the allocation number N received from the external device, and generating print data in which the pieces of image data are repeatedly allocated at one or more nines the number of which is equal to the repetition number, to N regions out of the M regions obtained by dividing the each of the print pages, based on the at least one of the predetermined number M and the allocation number N received from the external device.

### CROSS REFERENCE TO RELATED APPLICATION

The present application claims priority from a Japanese Patent Application No. 2006-071740 filed on Mar. 15, 2006, the contents of which are incorporated herein by reference.

### BACKGROUND

1. Technical Field

The present invention relates to a driver program, a printing apparatus control method, and a printing control apparatus. More particularly, the present invention relates to a driver program, a printing apparatus control method, and a printing control apparatus for generating print data in which a plurality of pieces of image data are allocated to a single print page.

2. Related Art

A printing control apparatus is publicly known which receives the setting of an allocation number indicating the number of pages that are desired to be printed on the single print page, and prints pages desired to be printed with multiple pages being allocated to the single print page in accordance with the received setting (see Patent Document 1, for example).

[Patent Document 1] Unexamined Japanese Patent Application Publication No. H11-147345

Here, the printing control apparatus disclosed in the Patent Document 1 can not perform printing in accordance with page allocation setting desired by users. For example, the printing control apparatus can not print one page to be printed in such a manner that a region of one piece of paper is divided into four regions and the page to be printed is allocated to three of the four regions.

### SUMMARY

To solve this problem, a first embodiment of the present invention is a driver program for controlling a printing apparatus. The driver program causes a computer to perform operations of obtaining one or more pieces of image data of one or more virtual pages from an image processing application, where the pieces of image data are in a one-to-one correspondence with the virtual pages, receiving, from an external device, at least one of (i) a predetermined number M indicating the number of regions obtained by dividing each of print pages to be printed by the printing apparatus and (ii) an allocation number N indicating the number of regions in the each of the print pages to which the pieces of image data are allocated, receiving, from an external device, a repetition number indicating the number of times at which the pieces of image data are repeatedly allocated to the print pages, dividing the each of the print pages into M regions based on the at least one of the predetermined number M and the allocation number N received from the external device, and generating print data in which the pieces of image data are repeatedly allocated at one or more times the number of which is equal to the repetition number, to N regions out of the M regions obtained by dividing the each of the print pages, based on the at least one of the predetermined number M and the allocation number N received from the external device. With the above-described configuration, one or more pages to be printed can be printed in such a manner as to be repeatedly allocated to the same print page. Also, not only the number of the regions obtained by dividing the region of each print page but also the number of regions in each print page to which the pieces of image data are allocated can be freely set.

The driver program may further cause the computer to perform an operation of providing a user interface for receiving, from an external device, selection made between (i) an option where the pieces of image data are repeatedly allocated at the times the number of which is equal to the repetition number to the N regions out of the M regions obtained by dividing the each of the print pages and (ii) an option where the pieces of image data are allocated once to the M regions obtained by dividing the each of the print pages. With the above-described configuration, a variety of options are offered to the users.

In the operation of receiving the at lea one of the predetermined number M and the allocation number N, the allocation number N may be received from the external device, and the predetermined number M may be determined so as to be an integer which is two or any composite number, equal to or larger than the allocation number N, and closest to the allocation number N. With the above-described configuration, only the allocation number N is received, and one or more pages to be printed can be therefore more easily printed in such a manner as to be repeatedly allocated to the same print page.

The driver program may further cause the computer to perform an operation of providing a user interface for receiving, from the external device, the allocation number N. With the above-described configuration, the allocation number N can be easily input.

In the operation of receiving the at least one of the predetermined number M and the allocation number N, both the predetermined number M and the allocation number N may be received from the external device. With the above-described configuration, one or more pages to be printed can be printed in such a manner as to be repeatedly allocated to the same print page, in accordance with a variety of needs of the users.

The driver program may further cause the computer to perform an operation of providing a user interface for receiving, from the external device, both the allocation number N and the predetermined number M. With the above-described configuration, the allocation number N and predetermined number M can be easily input.

In the operation of receiving the at least one of the predetermined number M and the allocation number N, the predetermined number M may be received from the external device and two or any composite number, and the allocation number N may be set so as to be the same as the predetermined number M. With the above-described configuration, only the predetermined number M is received, and one or more pages to be printed can be therefore more easily printed in such a manner as to be repeatedly allocated to the same print page.

The driver program may further cause the computer to perform an operation of providing a user interface for receiving, from the external device, two or any composite number as the predetermined number M. With the above-described configuration, the predetermined number M can be easily input.

To solve the above-mentioned problem, a second embodiment of the present invention provides a printing apparatus control method including obtaining one or more pieces of image data of one or more virtual pages from an image processing application, where the pieces of image data are in a one-to-one correspondence with the virtual pages, receiving, from an external device, at least one of (i) a predetermined number M indicating the number of regions obtained by dividing each of print pages to be printed by a printing apparatus and (ii) an allocation number N indicating the number of regions in the each of the print pages to which the pieces of image data are allocated, receiving, from an external device, a repetition number indicating the number of times at which the pieces of image data are repeatedly allocated to the print pages, dividing the each of the print pages into M regions based on the at least one of the predetermined number M and the allocation number N received from the external device, and generating print data in which the pieces of image data are repeatedly allocated at one or more times the number of which is equal to the repetition number, to N regions out of the M regions obtained by dividing the each of the print pages, based on the at least one of the predetermined number M and the allocation number N received from the external device. With the above-described configuration, the second embodiment produces the same effects as the first embodiment.

To solve the above-mentioned problem, a third embodiment of the present invention provides a printing control apparatus including an image data obtaining section that obtains one or more pieces of image data of one or more virtual pages from an image processing application, where the pieces of image data are in a one-to-one correspondence with the virtual pages, an external receiving section that receives, from an external device, at least one of (i) a predetermined number M indicating the number of regions obtained by dividing each of print pages to be printed by a printing apparatus and (ii) an allocation number N indicating the number of regions in the each of the print pages to which the pieces of image data are allocated, a repetition number receiving section that receives, from an external device, a repetition number indicating the number of times at which the pieces of image data are repeatedly allocated to the print pages, a region dividing section that divides the each of the print pages into M regions based on the at least one of the predetermined number M and the allocation number N received from the external device, and a print data generating section that generates print data in which the pieces of image data are repeatedly allocated at one or more times the number of which is equal to the repetition number, to N regions out of the M regions obtained by dividing the each of the print pages, based on the at least one of the predetermined number M and the allocation number N received from the external device. With the above-described configuration, the third embodiment produces the same effects as the first embodiment.

Here, all the necessary features of the present invention are not listed in the summary. The sub-combinations of the features may become the invention.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

FIG. 1 is a schematic view illustrating one example of a printing control apparatus 10. The printing control apparatus 10 includes therein a main unit 20, a display 40 which includes a display screen 42 and achieves a display based on the output from the main unit 20 for a user, a keyboard 44 and a mouse 46. Here, the keyboard 44 and mouse 46 are shown as one example of means for enabling the user to input data and the like into the main unit 20. A digital camera 50 and a scanner 60 are shown as one example of means for reading images, and connected to the main unit 20. A printer 70 performs printing on printing paper based on the output from the main unit 20. The printing control apparatus 10 can cause the printer 70 to perform printing in such a manner that one or more pieces of image data of virtual pages are repeatedly allocated to the same print page in accordance with the setting determined by the user. It should be noted that the print page represents a page in terms of sheets of paper on which printing is performed by the printer 70 and the virtual page represents a page in terms of the display achieved by an application process section 38 on the display screen 42 of the display 40.

FIG. 2 is a block diagram illustrating one example of the block configuration of the main unit 20. The main unit 20 includes therein a printing control section 30 and the application process section 38. The application process section 38 performs image processing on the images input by the digital camera 50 or scanner 60. The application process section 38 performs an operation to generate documents, tables or the like, instead of or in addition to the above-mentioned operation. The printing control section 30 generates print data based on the image data and the like acquired by the application process section 38, and outputs the generated print data to the printer 70. The printing control section 30 may be a printer driver for controlling the printer 70, for example.

The printing control section 30 includes therein an image data obtaining section 100, a setting input/output section 110, an allocation method selection receiving section 120, an external receiving section 130, a print data generating section 140, a repetition number receiving section 150, and a region dividing section 160. The image data obtaining section 100 obtains image data of each virtual page from the application process section 38.

The setting input/output section 110 provides a user interface relating to the print setting of the printer 70. To be specific, the setting input/output section 110 outputs, to the display screen 42 of the display 40, a window for receiving the input of print setting information relating to the print setting of the printer 70. The window and print setting information are described in detail with reference to FIGS. 3 and 4.

The external receiving section 130 includes therein a division number receiving section 132 and an allocation number receiving section 134. The division number receiving section 132 receives, via the setting input/output section 110, a division number M which is input into one of input regions 412 and 414 (described later). The allocation number receiving section 134 receives, via the setting input/output section 110, an allocation number N which is input into the input region 414 (described later). With the above-described configuration, the present embodiment can offer a variety of allocation methods to the user, when printing is performed in such a manner that one or more pages to be printed are repeatedly allocated to the same print page. Note that the division number M is presented as one example of a predetermined number M relating to the present invention.

The repetition number receiving section 150 receives a repetition number R from the user via the setting input/output section 110. The repetition number R indicates the number of times at which the pieces of image data of virtual pages are repeatedly allocated to print pages. The allocation method selection receiving section 120 receives a selected allocation method S from the user via the setting input/output section 110. The allocation method S is selected from an allocation method where the pieces of image data of the virtual pages are repeatedly allocated at multiple times the number of which is equal to the repetition number R, into N regions of the M regions obtained by dividing each print page, and an allocation method where the pieces of image data of the virtual pages are allocated once into the M regions of each print page.

The region dividing section 160 divides each print page into M regions based on the division number M received from the user via the setting input/output section 110. The print data generating section 140 generates print data in which the pieces of image data of the virtual pages are repeatedly allocated at multiple times the number of which is equal to the repetition number into N regions of the M regions obtained by dividing each print page, based on the allocation number N and the like received from the user via the setting input/output section 110.

A storage medium 80 stores thereon a program to realize operations of the image data obtaining section 100, setting input/output section 110, allocation method selection receiving section 120, external receiving section 130, print data generating section 140, repetition number receiving section 150 and region dividing section 160. The main unit 20 may perform the operations of the sections including the image data obtaining section 100 when installed with the program stored on the storage medium 80. Alternatively, the main unit 20 may acquire such a program through the communication lines. Here, the program may be a driver program to control the printer 70.

FIG. 3 is a schematic view illustrating a window 400 output from the setting input/output section 110. FIG. 4 is a schematic view illustrating a window 410 output from the setting input/output section 110. The window 400 is displayed, for example, when the application process section 38 receives an operation by the user in relation to the print setting. The window 400 has entry fields including a print copy number entry field for receiving input of the number of copies to be printed B, an allocation setting button for displaying the window 410, an OK button for transmitting the determined print setting information to the setting input/output section 110, and the like. It should be noted here that the allocation setting indicates setting determined for allocating virtual pages to the regions obtained by dividing each print page. The setting input/output section 110 receives the print setting information determined by way of the windows 400 and 410 when the OK button of the window 400 is pressed.

The window 410 is displayed when the allocation setting button of the window 400 is pressed. The window 410 has radio buttons for receiving the selection of the allocation method S. As shown in FIG. 4, the radio buttons include a “single allocation” button and a “repeated allocation” button as options. The “single allocation” button is selected to allocate the pieces of image data of the virtual pages once to the M regions obtained by dividing each print page. The “repeated allocation” button is selected to repeatedly allocate the pieces of image data of the vital pages at multiple times the number of which is equal to the repetition number R into the N regions of the M regions obtained by dividing each print page. When the OK button of the window 400 is pressed, the setting input/output section 110 receives the allocation method S=0 as the print setting information if the “single allocation” button is selected, and receives the allocation method S=1 as the print setting information if the “repeated allocation” button is selected.

The window 410 has the input region 412 for receiving additional input by the user when the “single allocation” button is selected. The input region 412 has radio buttons for receiving selection of the value of the division number M.

The window 410 has the input region 414 for receiving additional input by the user when the “repeated allocation” button is selected. The input region 414 has a repetition number entry field for receiving the input of the repetition number R, radio buttons for receiving the selection of the value of the division number M, and an allocation number entry field for receiving the input of the allocation number N. The radio buttons for receiving the selection of the value of the division number M provide options of 2, 4, 6, 8 and 9 as shown in FIG. 4, for example. When the option of “4” is selected among the radio buttons for receiving the selection of the value of the division number M, the print page is divided into two regions vertically and horizontally (in total, four regions are created). Here, the allocation number N input by the user is preferably equal to or smaller than the selected division number M. More specifically, it is preferable that the selection of a value larger than the division number M is not received for the allocation number NV The options provided by the radio buttons for receiving the selection of the value of the division number M are not limited to the numbers shown in FIG. 4. For example, the numbers of 12 and 16 may be added. Here, the division number M is preferably two or any composite number.

The window 410 additionally has buttons such as radio buttons for receiving selection of an allocation order J of allocating the virtual pages to each print page, a virtual page display field for displaying the number of virtual pages to be printed P, a print copy number display field for displaying the print copy number B, and an OK button for fixing the determined contents. The setting input/output section 110 obtains the number of virtual pages to be printed P from the application process section 38, and displays the obtained virtual page number P in the virtual page display field. Also, the setting input/output section 110 displays the print copy number B determined through the print copy number entry field of the window 400, in the print copy number display field.

FIGS. 5 to 7 are flow charts to illustrate one example of the operation of the printing control apparatus 10. FIGS. 8A and 8B are schematic views each illustrating one example of a result of printing performed by printer 70. The procedure illustrated by the flow chart of FIG. 5 starts when the OK button of the window 400 is pressed. It is assumed that the print setting information is set as shown in FIG. 4 (for example, the virtual page number P=2, the print copy number B=1, the allocation method S=1 (repeated allocation), the repetition number R=3, the division number M=4, the allocation number N=4, the information relating to the allocation order J, and the like) when the procedure illustrated by the flow chart of FIG. 5 starts. It is also assumed that the image data obtaining section 100 has already obtained virtual pages from the application process section 38 when the procedure indicated by the flow chart of FIG. 5 starts.

The setting input/output section 110 receives the print setting information determined (input) through the windows 400 and 410. Specifically speaking, the setting input/output section 110 receives the virtual page number P=2, the print copy number B=1 , the allocation method S=1, the repetition number R=3, the division number M=4, the allocation number N=4, the information relating to the allocation order J, and the like.

The allocation method selection receiving section 120 receives the allocation method S=1 from the setting input/output section 110 (step S110). The allocation method selection receiving section 120 then judges whether the repeated allocation is selected (step S120). When the received allocation method S is 1, the allocation method selection receiving section 120 judges that the repeated allocation is selected (step S120:Yes). The division number receiving section 132 receives the division number M=4 from the setting input/output section 110 (step S130), the allocation number receiving section 134 receives the allocation number N=4 from the setting input/output section 110 (step S140), and the repetition number receiving section 150 receives the repetition number R=3 from the setting input/output section 110 (step S150). The region dividing section 160 obtains the division number M=4 from the division number receiving section 132 and the allocation number N=4 from the allocation number receiving section 134. The region dividing section 160 divides each print page into four regions based on the division number M=4 (step S160).

The print data generating section 140 obtains virtual pages (two virtual pages) from the image data obtaining section 100, the repetition number R=3 from the repetition number receiving section 150, and the allocation number N=4 from the region dividing section 160. The print data generating section 140 generates print data based on the repetition number R=3 and the allocation number N=4 (step S400). Also, the print data generating section 140 transmits the generated print data to the printer 70 (step S400). After this, the print data generating section 140 discards the transmitted print data (step S190). After this, the procedure illustrated,by this flow chart ends. The step S400 is described in detail later with reference to FIG. 6.

Alternatively, if the print setting information is set in such a manner that the allocation method S is determined to 0 or single allocation (the virtual page number P=2, the print copy number B=1, the allocation method S=0, the division number M=4, the information relating to the allocation order J, and the like) when the procedure illustrated by the flow chart of FIG. 5 starts, the allocation method selection receiving section 120 judges that the repeated allocation is not selected based on the received allocation method S=0 (step S120:No). The division number receiving section 132 receives the division number M=4 from the setting input/output section 110 (step S170). The region dividing section 160 receives the division number M=4 from the division number receiving section 132. Subsequently, the region dividing section 160 divides each print page into four regions based on the division number M=4 (step S180). The print data generating section 140 obtains the virtual pages (two virtual pages) from the image data obtaining section 100. The print data generating section 140 then generates print data (step S500). The print data generating section 140 transmits the generated print data to the printer 70 (step S500). Also, the print data generating section 140 discards the transmitted print data (step S190). After this, the procedure illustrated by the flow chart of FIG. 5 ends. The step S500 is described in detail later with reference to FIG. 7.

The flow chart shown in FIG. 6 illustrates one example of the operation performed in the step S400 shown in FIG. 5. Here, when completing the operation of the step S160, the region dividing section 160 notifies the print data generating section 140 of the completion.

The print data generating section 140 allocates one virtual page (first virtual page) to one region (upper left region) of the N (=4) regions of one print page (first print page) (step S410). Here, the print data generating section 140 determines which one of the regions is allocated with the virtual page, based on the information relating to the allocation order J.

The print data generating section 140 judges whether all the virtual pages are allocated at multiple times the number of which is equal to the repetition number R=3 (step S420). In other words, the print data generating section 140 judges whether the number of the virtual pages having been allocated is equal to the number (=6) of virtual pages to be allocated which is obtained by multiplying together the virtual page number P=2 and the repetition number R=3 (step S420).

When judged negatively in the step S420 (step S420:No), the print data generating section 140 judges whether the N (=4) regions of the print page are all allocated with the virtual pages (step S430).

When judged negatively in the step S430 (step S430:No), the print data generating section 140 allocates the next virtual page (second virtual page) to the next region (upper right region) of the print page (step S440).

When judged positively in the step S430 (step S430:Yes), the print data generating section 140 transmits the print page (first print page) to the printer 70 (step S450). Subsequently, the print data generating section 140 allocates the next virtual page to one region (upper left region) of the N (=4) regions of the next print page (second print page) (step S460).

When judged positively in the step S420 (step S420:Yes), the print data generating section 140 transmits the print page to the printer 70 (step S470). Subsequently, the procedure illustrated by the flow chart of FIG. 6 ends, and the step S190 of the procedure shown by the flow chart of FIG. 5 is executed. Note that FIG. 8A shows the result of the printing performed based on the print setting information set as described above (the print copy number B=1, the allocation method S=1, the repetition number R=3, the division number M=4, and the allocation number N=4).

FIG. 7 is a flow chart illustrating one example of the operation performed in the step S500 shown in FIG. 5. Note that when completing the operation in the step S180, the region dividing section 160 notifies the print data generating section 140 of the completion.

The print data generating section 140 allocates one virtual page (first virtual page) to one region (upper left region) of the N (=4) regions of one print page (first print page) (step S510). Subsequently, the print data generating section 140 judges whether the number of allocated virtual pages is equal to the virtual page number P=2 (step S520).

When judged negatively in the step S520 (step S520:No), the print data generating section 140 allocates the next virtual page (second virtual page) to the next region (upper right region) of the print page (step S540).

When judged positively in the step S520 (step S520:Yes), the print data generating section 140 transmits the print page to the printer 70 (step S570). Subsequently, the procedure illustrated by the flow chart of FIG. 7 ends, and the step S190 of the procedure shown by the flow chart of FIG. 5 is executed. Note that FIG. 8B shows the result of the printing performed based on the print setting information set as described above (the print copy number B=1, the allocation method S=0, and the division number M=4).

FIG. 9 is a schematic view illustrating another example of the result of the printing performed by the printer 70. FIGS. 10A and 10B are schematic views each illustrating one example of the result of the printing performed by the printer 70. Specifically speaking, FIG. 9 shows the result of printing performed when the print setting information is set, for example, in such a manner that the virtual page number P=2, the print copy number B=1, the allocation method S=1, the repetition number R=3, the division number M=6, and the allocation number N=5 when the procedure illustrated by the flow chart of FIG. 5 starts. In this print setting information, the division number M and allocation number N are different from each other. FIG. 10A shows the result of printing performed when the pat setting information is set, for example, in such a manner that the virtual page number P=2, the print copy number B=5, the allocation method S=1, the repetition number R=3, the division number M=4, and the allocation number N=4 when the procedure illustrated by the flow chart of FIG. 5 starts. In this print setting information, the print copy number is more than one. FIG. 10B shows the result of printing performed when the print setting information is set, for example, in such a manner that the virtual page number P=2, the print copy number B=5, the allocation method S=0, and the division number M=4 when the procedure illustrated by the flow chart of FIG. 5 starts. This print setting information is another example of print setting information in which the print copy number is set to more than one.

FIG. 11 is a block diagram illustrating another example of the block configuration of the main unit 20. The block configuration shown in the block diagram is utilized when the pieces of image data of the virtual pages are repeatedly allocated across one or more print pages based on the allocation number N which is designated by the user and the division number M which is calculated by using the allocation number N designated by the user. The main unit 20 includes therein a printing control section 32 and the application process section 38. The application process section 38 is the same as the application process section 38 shown in FIG. 2, and thus not explained here. The printing control section 32 may be a printer driver for controlling the printer 70, for example.

The printing control section 32 includes therein the image data obtaining section 100, a setting input/output section 210, the allocation method selection receiving section 120, an external receiving section 230, the print data generating section 140, the repetition number receiving section 150, and the region dividing section 160. The image data obtaining section 100, allocation method selection receiving section 120, print data generating section 140, repetition number receiving section 150 and region dividing section 160 are the same as the corresponding constituents shown in FIG. 2, and thus not explained here.

The setting input/output section 210 provides a different user interface from the setting input/output section 110. Specifically speaking, the setting input/output section 210 outputs a window 420 in place of the window 410 output from the setting input/output section 110. The window 420 is described later in detail with reference to FIG. 12.

The external receiving section 230 includes therein an allocation number receiving section 232, a division number calculating section 234 and a division number receiving section 236. The allocation number receiving section 232 receives the allocation number N input into an input region 424 (described later) via the setting input/output section 210. The division number calculating section 234 calculates the division number M based on the allocation number N received by the allocation number receiving section 232. In this way, only the allocation number N is received, and printing can be therefore more easily performed in such a manner that one or more pages to be printed can be repeatedly allocated to the same print page. The division number receiving section 236 receives the division number M input into an input region 422 (described later) via the setting input/output section 210.

FIG. 12 is a schematic view illustrating the window 420 output from the setting input/output section 210. The window 420 is displayed in place of the window 410 shown in FIG. 4 when the allocation setting button of the window 400 shown in FIG. 3 is pressed. Similarly to the window 410 shown in FIG. 4, the window 420 has the input region 422 for receiving the additional input by the user when the “single allocation” button is selected, and the input region 424 for receiving the additional input by the user when the “repeated allocation” button is selected. The input region 422 has radio buttons for receiving the selection of the value of the division number M, similarly to the input region 412 shown in FIG. 4. On the other hand, the input region 424 only has the repetition number entry field for receiving the input of the repetition number R, and the allocation number entry field for receiving the input of the allocation number N, differently from the input region 414 shown in FIG. 4.

The window 420 additionally has buttons such as the radio buttons for receiving the selection of the allocation order J of allocating the virtual pages to the print pages, the virtual page display field for displaying the number of virtual pages to be printed P, the print copy number display field for displaying the print copy number B, and an OK button for fixing the set contents, similarly to the window 410 shown in FIG. 4.

FIG. 13 is a flow chart illustrating one example of the operation performed by the printing control apparatus 10 having the block configuration shown in FIG. 1l. FIG. 14 is a schematic view illustrating one example of the result of the printing performed by the printer 70 shown in FIG. 13. The procedure illustrated by the flow chart shown in FIG. 13 starts when the OK button of the window 400 is pressed. Here, it is assumed that the print setting information is set as shown in FIG. 12 (the virtual page number P=2, the print copy number B=1, the allocation method S=1 (repeated allocation), the repetition number R=3, and the allocation number N=3) when the procedure illustrated by the flow chart of FIG. 13 starts. Also, it is assumed that the image data obtaining section 100 has obtained the virtual pages from the application process section 38 when the procedure illustrated by the flow chart of FIG. 13 starts. In the following description, the steps performed in the same manner as in the corresponding steps of the procedure shown by the flow chart of FIG. 5 are only briefly mentioned.

The setting input/output section 210 receives the input of the print setting information determined through the windows 400 and 420. Specifically speaking, the setting input/output section 210 receives the virtual page number P=2, the print copy number B=1, the allocation method S=1, the repetition number R=3, the allocation number N=3, the information relating to the allocation order, and the like.

The allocation method selection receiving section 120 receives the allocation method S=1 from the setting input/output section 210 (step S210). The allocation method selection receiving section 120 judges whether the repeated allocation is selected (step S220). When the received allocation method S is set to “1” the allocation method selection receiving section 120 judges that the repeated allocation is selected (step S220:Yes). Subsequently, the allocation number receiving section 232 receives the allocation number N=3 from the setting input/output section 210 (step S230). Following this, the division number calculating section 234 calculates the division number M=4 based on the allocation number N=3 received by the allocation number receiving section 232 (step S240). To be specific, the division number calculating section 234 calculates “4”, as the division number M, because “4” satisfies the conditions of two or any composite number, equal to or larger than the allocation number N=3, and an integer which is the closest to the allocation number N=3 (step S240). After this, the repetition number receiving section 150 receives the repetition number R=3 from the setting input/output section 210 (step S250). Subsequently, the region dividing section 160 receives the allocation number N=3 and the division number M=4 from the division number calculating section 234. The region dividing section 160 divides each print page into four regions based on the division number M=4 (step S260).

The print data generating section 140 obtains the virtual pages (two virtual pages) from the image data obtaining section 100, the repetition number R=3 from the repetition number receiving section 150, and the allocation number N=3 from the region dividing section 160. The print data generating section 140 generates the print data based on the repetition number R=3 and the allocation number N=3 (step S400). Also, the print data generating section 140 transmits the generated print data to the printer 70 (step S400). The print data generating section 140 then discards the transmitted print data (step S290). Subsequently, the procedure shown by the flow chart of FIG. 13 ends. Here, the step S400 is the same as the step S400 of the procedure shown by the flow chart of FIG. 5, and therefore not explained here. FIG. 14 shows the result of the printing performed based on the print setting information which is set in such a manner that the virtual page number P=2, the print copy number B=1, the allocation method S=1 (repeated allocation), the repetition number R=3, and the allocation number N=3.

On the other hand, if the print setting information is set, for example, in such a manner that the allocation method S=0 (single allocation), the virtual page number P=2, the print copy number B=1, and the division number M=4 when the procedure shown by the flow chart of FIG. 13 starts, the allocation method selection receiving section 120 judges that the repeated allocation is not selected based on the received allocation method S=0 (step S220:No). The division number receiving section 236 receives the division number M=4 from the setting input/output section 210 (step S270). The region dividing section 160 and print data generating section 140 respectively perform the steps S280 and S500 which are the same as the steps S180 and S500 of the procedure shown by the flow chart of FIG. 5. Therefore, the steps S280 and S500 are not mentioned here.

FIG. 15 is a block diagram illustrating another example of the block configuration of the main unit 20. The block configuration shown by the block diagram is utilized when the pieces of image data of the virtual pages are repeatedly allocated to the print pages based on the division number M designated by the user and the allocation number N calculated by using the division number M designated by the user. The main unit 20 includes therein a printing control section 34 and the application process section 38. The application process section 38 is the same as the application process section 38 shown in FIG. 2, and therefore not mentioned here. The printing control section 34 may be a printer driver for controlling the printer 70, for example.

The printing control section 34 includes therein the image data obtaining section 100, a setting input/output section 310, the allocation method selection receiving section 120, an external receiving section 330, the print data generating section 140, the repetition number receiving section 150, and the region dividing section 160. The image data obtaining section 100, allocation method selection receiving section 120, print data generating section 140, repetition number receiving section 150 and region dividing section 160 are the same as the corresponding constituents shown in FIG. 2, and thus not explained here.

The setting input/output section 310 provides a different user interface from the setting input/output sections 110 and 210. Specifically speaking, the setting input/output section 310 outputs a window 430 in place of the windows 410 and 420 respectively output from the setting input/output sections 110 and 210. The window 430 is described later in detail with reference to FIG. 16.

The external receiving section 330 includes therein a division number receiving section 332, an allocation number calculating section 334 and a division number receiving section 336. The division number receiving section 332 receives the division number M input into an input region 434 (described later) via the setting input/output section 310. The allocation number calculating section 334 calculates the allocation number N based on the division number M received by the division number receiving section 332. In this way, only he division number M is received, and printing can be therefore more easily performed in such a manner that one or more pages to be printed can be repeatedly allocated to the same print page. The division number receiving section 336 receives the division number M input into an input region 432 (described later) via the setting input/output section 310.

FIG. 16 is a schematic view illustrating the window 430 output from the setting input/output section 310. The window 430 is displayed in place of the window 410 shown in FIG. 4 when the allocation setting button of the window 400 shown in FIG. 3 is pressed. Similarly to the window 410 shown in FIG. 4, the window 430 has the input region 432 for receiving the additional input by the user when the “single allocation” button is selected, and the input region 434 for receiving the additional input by the user when the “repeated allocation” button is selected. The input region 432 has radio buttons for receiving the selection of the value of the division number M, similarly to the input region 412 shown in FIG. 4. On the other hand, the input region 434 only has the repetition number entry field for receiving the input of the repetition number R, and the radio buttons for receiving the selection of the value of the division number M, differently from the input region 414 shown in FIG. 4.

The window 430 additionally has buttons such as the radio buttons for receiving the selection of the allocation order J of allocating the virtual pages to the print pages, the virtual page display field for displaying the number of virtual pages to be printed P, the print copy number display field for displaying the print copy number B, and the OK button for fixing the set contents, similarly to the window 410 shown in FIG. 4.

FIG. 17 is a flow chart illustrating one example of the operation performed by the printing control apparatus 10 having the block configuration shown in FIG. 15. The procedure illustrated by the flow chart shown in FIG. 17 starts when the OK button of the window 400 is pressed. Here, it is assumed that the print setting information is set as shown in FIG. 16 (the virtual page number P=2, the print copy number B=1, the allocation method S=1 (repeated allocation), the repetition number R=3, and the division number M=4) when the procedure illustrated by the flow chart of FIG. 17 starts. Also, it is assumed that the image data obtaining section 100 has obtained the virtual pages from the application process section 38 when the procedure illustrated by the flow chart of FIG. 17 starts. In the following description, the steps performed in the same manner as in the corresponding steps of the procedure shown by the flow chart of FIG. 5 are only briefly mentioned.

The setting input/output section 310 receives the input of the print setting information determined through the windows 400 and 430. Specifically speaking, the setting input/output section 310 receives the virtual page number P=2, the print copy number B=1, the allocation method S=1, the repetition number R=3, the division number M=4, the information relating to the allocation order, and the like.

The allocation method selection receiving section 120 receives the allocation method S=1 from the setting input/output section 310 (step S310). The allocation method selection receiving section 120 judges whether the repeated allocation is selected (step S320). When the received allocation method S is set to “1”, the allocation method selection receiving section 120 judges that the repeated allocation is selected (step S320:Yes). Subsequently, the division number receiving section 332 receives the division number M=4 from the setting input/output section 310 (step S330). Following this, the allocation number calculating section 334 calculates the allocation number N=4 based on the division number M=4 received by the division number receiving section 332 (step S340). In this case, the allocation number calculating section 334 selects, for the allocation number N, the same value as the value of the predetermined value M (step S340). After this, the repetition number receiving section 150 receives the repetition number R=3 from the setting input/output section 310 (step S350). Subsequently, the region dividing section 160 receives the allocation number N=4 and the division number M=4 from the allocation number calculating section 334. The region dividing section 160 divides each print page into four regions based on the division number M=4 (step S360).

The print data generating section 140 obtains the virtual pages (two virtual pages) from the image data obtaining section 100, the repetition number R=3 from the repetition number receiving section 150, and the allocation number N=4 from the region dividing section 160. The print data generating section 140 generates the print data based on the repetition number R=3 and the allocation number N=4 (step S400). Also, the print data generating section 140 transmits the generated print data to the printer 70 (step S400). The print data generating section 140 then discards the transmitted print data (step S390). Subsequently, the procedure shown by the flow chart of FIG. 17 ends. Here, the step S400 is the same as the step S400 of the procedure shown by the flow chart of FIG. 5, and therefore not explained here.

On the other hand, if the print setting information is set, for example, in such a manner that the allocation method S=0 (single allocation), the virtual page number P=2, the print copy number B=1, and the division number M=4 when the procedure shown by the flow chart of FIG. 17 starts, the allocation method selection receiving section 120 judges that the repeated allocation is not selected based on the received allocation method S=0 (step S320:No). The division number receiving section 336 receives the division number M=4 from the setting input/output section 310 (step S370). The region dividing section 160 and print data generating section 140 respectively perform the steps S380 and S500 which are the same as the steps S180 and S500 of the procedure shown by the flow chart of FIG. 5. Therefore, the steps S380 and S500 are not mentioned here.

As described above, the present embodiments of the present invention enable printing to be performed in such a manner that one or more pages to be printed are repeatedly allocated to the same print page. Therefore, the present embodiments can easily produce a sheet of printed paper with multiple discount coupons each one of which is torn off the paper to be used, for example. According to the present embodiments, not only the number of the regions obtained by dividing each print page but also the number of the regions, in each print page, to which the virtual pages are allocated can be designated by the user. Therefore, the present embodiments enable the size of each discount coupon and the number of the discount coupons to be printed on the paper to be easily designated by the user, for example.

While the embodiments of the present invention have been described, the technical scope of the invention is not limited to the above described embodiments. It is apparent to persons skilled in the art that various alternations and improvements can be added to the above-described embodiments. It is also apparent from the scope of the claims that the embodiments added with such alternations or improvements can be included in the technical scope of the invention.

### BRIEF DESCRIPTION OF THE DRAWINGS

FIG. 1 is a schematic view illustrating one example of a printing control apparatus 10.

FIG. 2 is a block diagram illustrating one example of the block configuration of a main unit 20.

FIG. 3 is a schematic view illustrating a window 400 output from a setting input/output section 110.

FIG. 4 is a schematic view illustrating a window 410 output from the setting input/output section 110.

FIG. 5 is a flow chart illustrating one example of the operation of the printing control apparatus 10.

FIG. 6 is a flow chart illustrating one example of the operation performed in a step S400.

FIG. 7 is a flow chart illustrating one example of the operation performed in a step S500.

FIG. 8A is a schematic view illustrating one example of a result of printing performed by a printer 70.

FIG. 8B is a schematic view illustrating one example of a result of the printing performed by the printer 70.

FIG. 9 is a schematic view illustrating another example of the result of the printing performed by the printer 70.

FIG. 10A is a schematic view illustrating another example of the result of the printing performed by the printer 70.

FIG. 10B is a schematic view illustrating another example of the result of the printing performed by the printer 70.

FIG. 11 is a block diagram illustrating another example of the block configuration of the main unit 20.

FIG. 12 is a schematic view illustrating a window 420 output from a setting input/output section 210.

FIG. 13 is a flow chart illustrating one example of the operation performed by the printing control apparatus 10 having the block configuration shown in FIG. 11.

FIG. 14 is a schematic view illustrating another example of the result of the printing performed by the printer 70.

FIG. 15 is a block diagram illustrating another example of the block configuration of the main unit 20.

FIG. 16 is a schematic view illustrating a window 430 output from a setting input/output section 310.

FIG. 17 is a flow chart illustrating one example of the operation performed by the printing control apparatus 10 having the block configuration shown in FIG. 15.

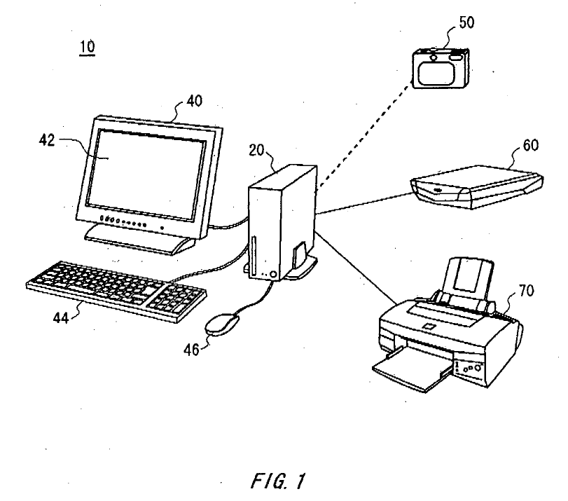

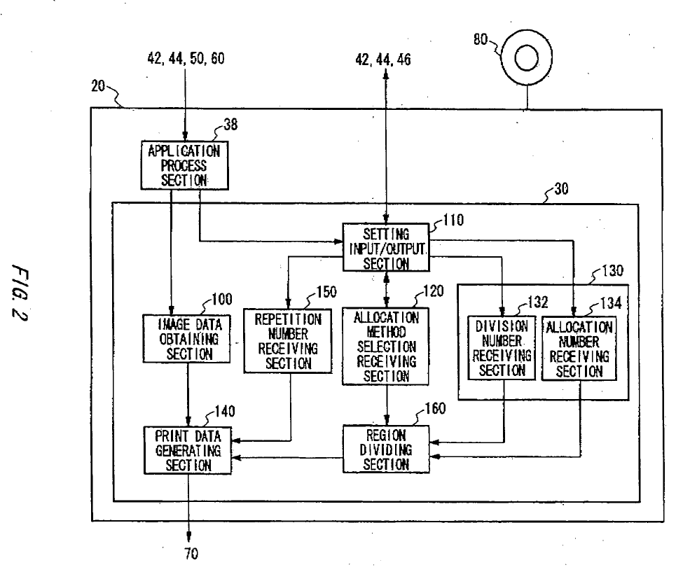

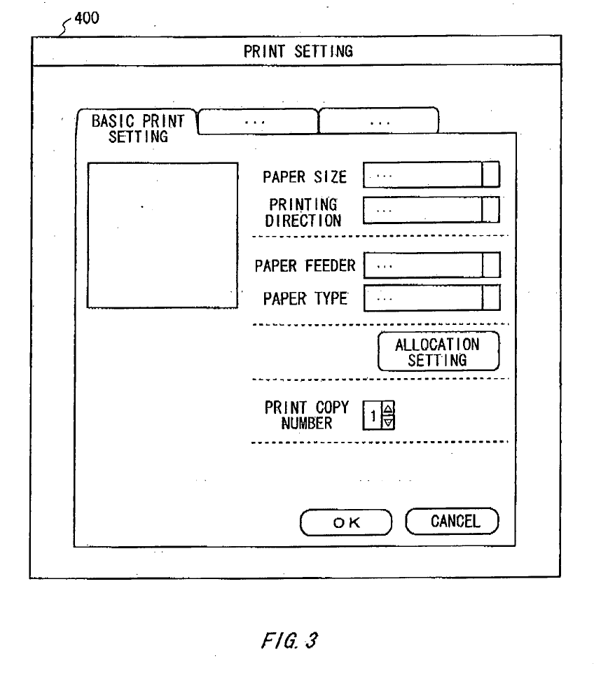

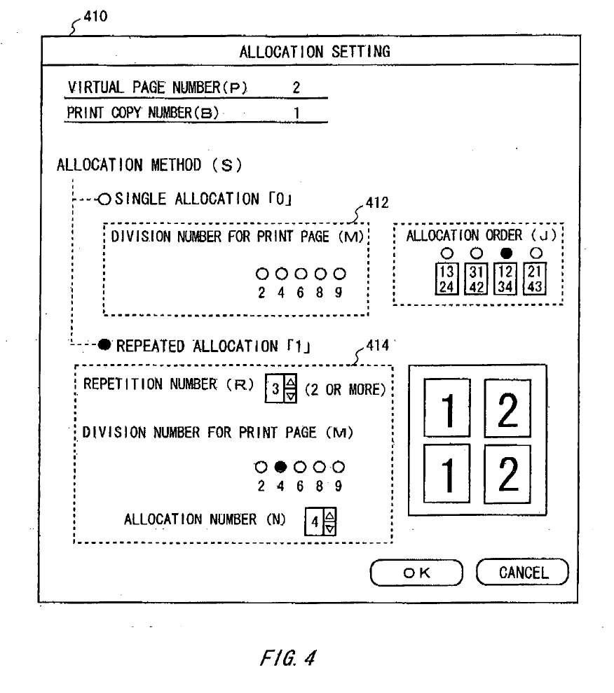

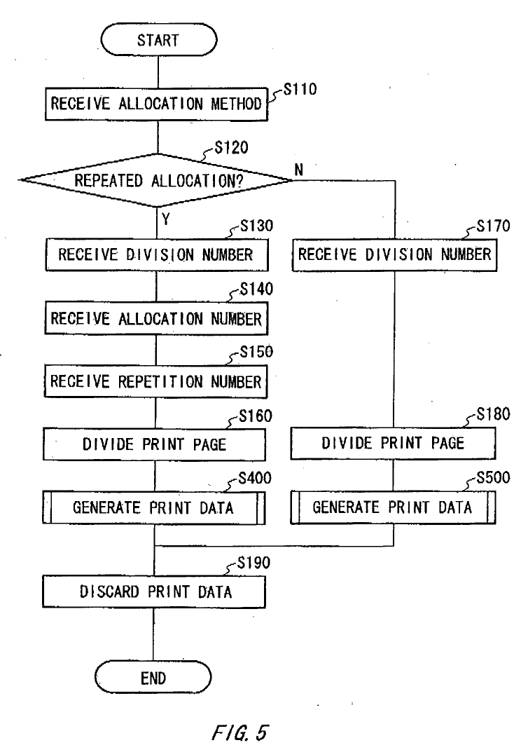

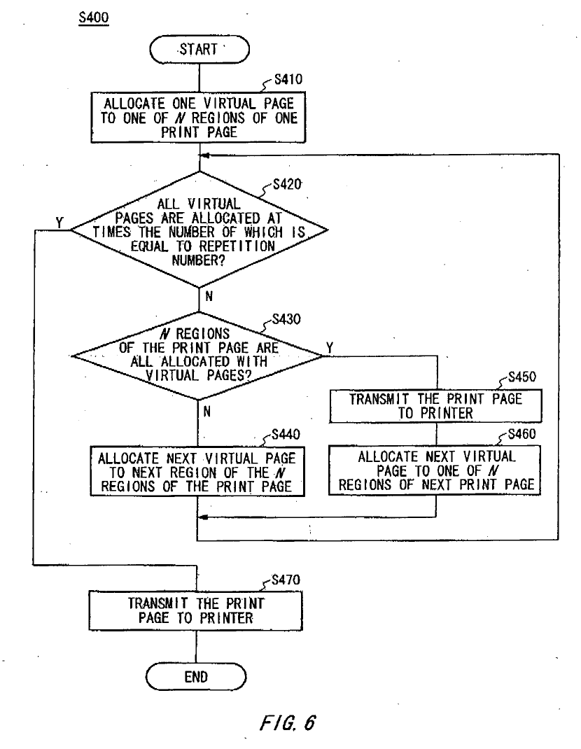

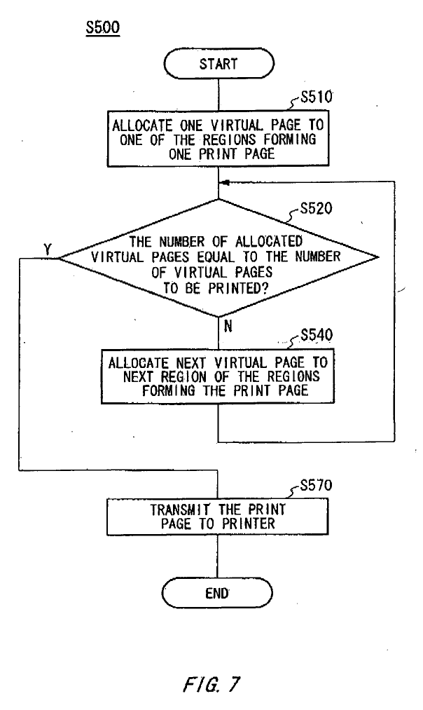

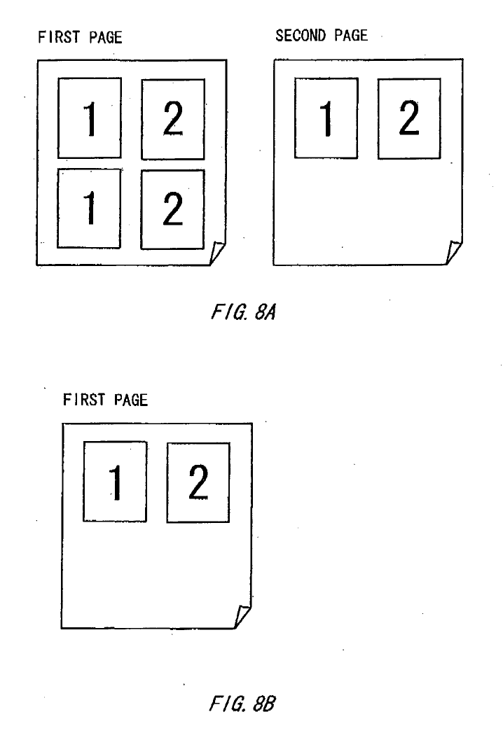

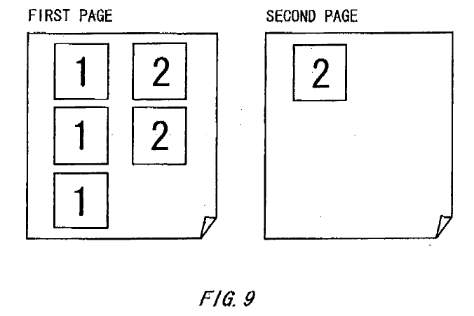

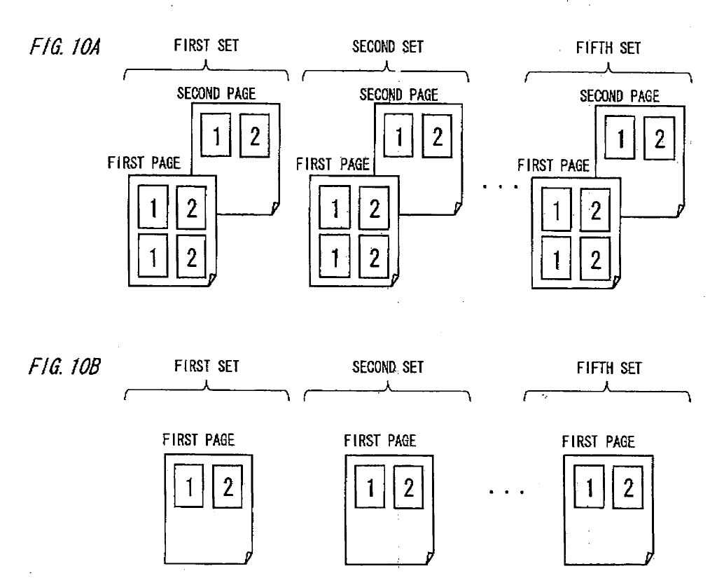

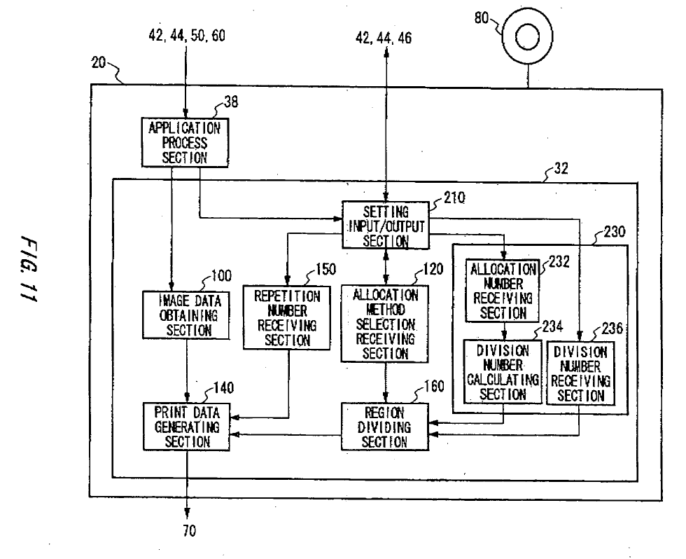

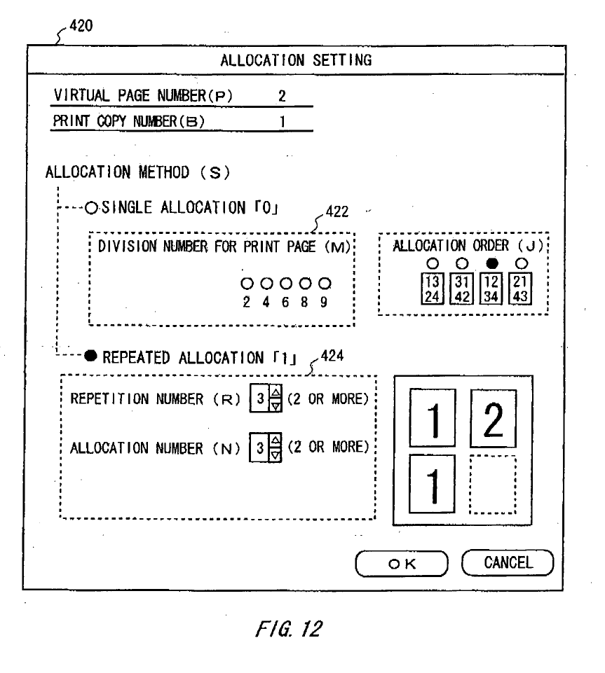

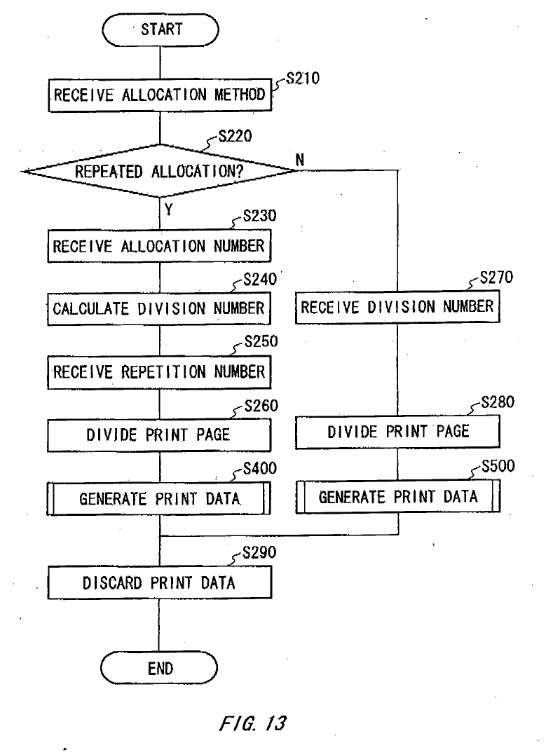

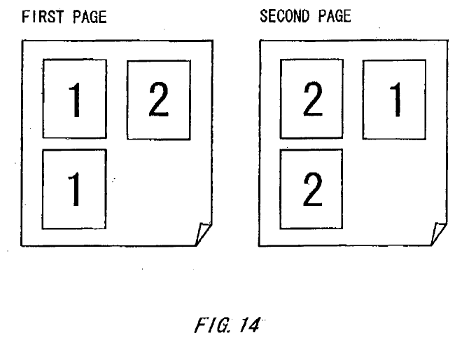

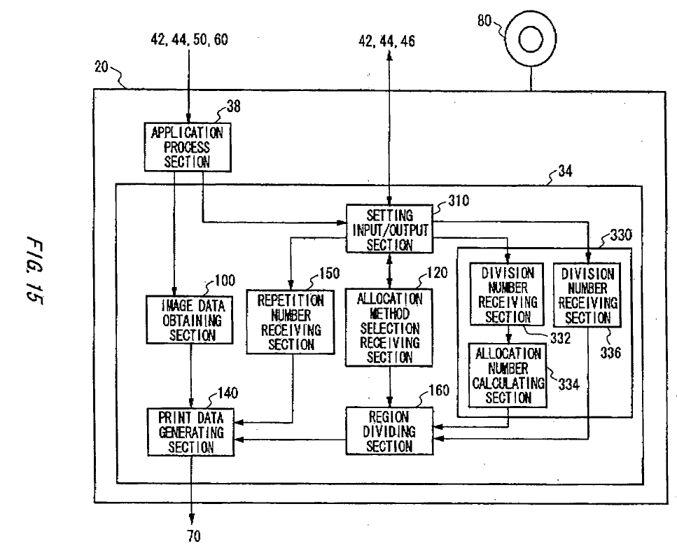

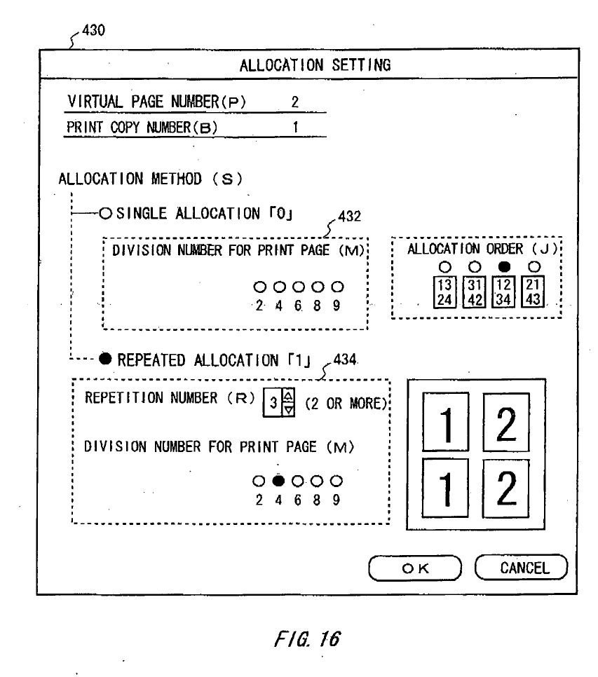

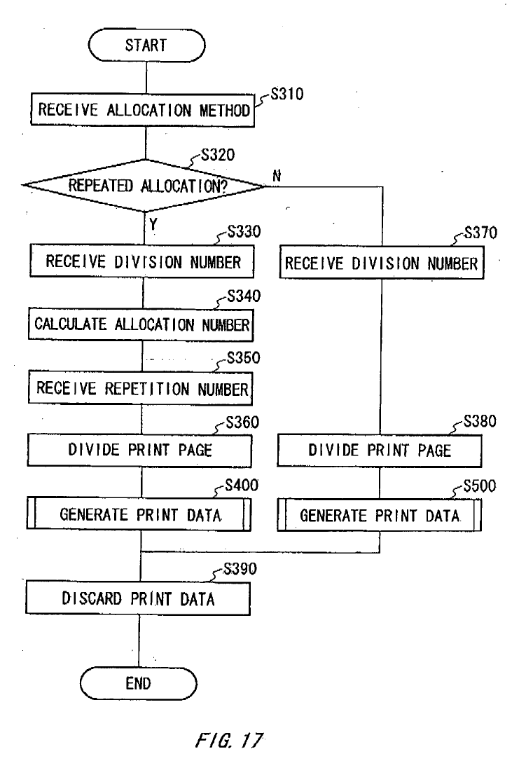

What is claimed is:

1. A driver program for controlling a printing apparatus, the driver program causing a computer to perform operations of:
obtaining one or more pieces of image data of one or more virtual pages from an image processing application, the pieces of image data being in a one-to-one correspondence with the virtual pages;
receiving, from an external device, at least one of (i) a predetermined number M indicating the number of regions obtained by dividing each of print pages to be printed by the printing apparatus and (ii) an allocation number N indicating the number of regions in the each of the print pages to which the pieces of image data are allocated;
receiving, from an external device, a repetition number indicating the number of times at which the pieces of image data are repeatedly allocated to the print pages;
dividing the each of the print pages into M regions based on the at least one of the predetermined number M and the allocation number N received from the external device; and
generating print data in which the pieces of image data are repeatedly allocated at one or more times the number of which is equal to the repetition number, to N regions out of the M regions obtained by dividing the each of the print pages, based on the at least one of the predetermined number M and the allocation number N received from the external device.

2. The driver program as set forth in claim 1, further causing the computer to perform an operation of
providing a user interface for receiving, from an external device, selection made between (i) an option where the pieces of image data are repeatedly allocated at the times the number of which is equal to the repetition number to the N regions out of the M regions obtained by dividing the each of the print pages and (ii) an option where the pieces of image data are allocated once to the M regions obtained by dividing the each of the print pages.

3. The driver program as set forth in claim 1, wherein
in the operation of receiving the at least one of the predetermined number M and the allocation number N, the allocation number N is received from the external device, and the predetermined number M is determined so as to be an integer which is two or any composite number, equal to or larger than the allocation number N, and closest to the allocation number N.

4. The driver program as set fort in claim 3, further causing the computer to perform an operation of
providing a user interface for receiving, from the external device, the allocation number N.

5. The driver program as set forth in claim 1, wherein
in the operation of receiving the at least one of the predetermined number M and the allocation number N, both the predetermined number M and the allocation number N are received from the external device.

6. The driver program as set forth in claim 5, further causing the computer to perform an operation of
providing a user interface for receiving, from the external device, both the allocation number N and the predetermined number M.

7. The driver program as set forth in claim 1, wherein
in the operation of receiving the at least one of the predetermined number M and the allocation number N, the predetermined number M is received from the external device and two or any composite number, and the allocation number N is set so as to be the same as the predetermined number M.

8. The driver program as set forth in claim 7, further causing the computer to perform an operation of
providing a user interface for receiving, from the external device, two or any composite number as the predetermined number M.

9. A printing apparatus control method comprising:
obtaining one or more pieces of image data of one or more virtual pages from an image processing application, the pieces of image data being in a one-to-one correspondence with the virtual pages;
receiving, from an external device, at least one of (i) a predetermined number M indicating the number of regions obtained by dividing each of print pages to be printed by a printing apparatus and (ii) an allocation number N indicating the number of regions in the each of the print pages to which the pieces of image data are allocated;
receiving, from an external device, a repetition number indicating the number of times at which the pieces of image data are repeatedly allocated to the print pages;
dividing the each of the print pages into M regions based on the at least one of the predetermined number M and the allocation number N received from the external device; and
generating print data in which the pieces of image data are repeatedly allocated at one or more times the number of which is equal to the repetition number, to N regions out of the M regions obtained by dividing the each of the print pages, based on the at least one of the predetermined number M and the allocation number N received from the external device.

10. A printing control apparatus comprising:
an image data obtaining section that obtains one or more pieces of image data of one or more virtual pages from an image processing application, the pieces of image data being in a one-to-one correspondence with the virtual pages;
an external receiving section that receives, from an external device, at least one of (i) a predetermined number M indicating the number of regions obtained by dividing each of print pages to be printed by a printing apparatus and (ii) an allocation number N indicating the number of regions in the each of the print pages to which the pieces of image data are allocated;
a repetition number receiving section that receives, from an external device, a repetition number indicating the number of times at which the pieces of image data are repeatedly allocated to the print pages;
a region dividing section that divides the each of the print pages into M regions based on the at least one of the predetermined number M and the allocation number N received from the external device; and
a print data generating section that generates print data in which the pieces of image data are repeatedly allocated at one or more times the number of which is equal to the repetition number, to NV regions out of the M regions obtained by dividing the each of the print pages, based on the at least one of the predetermined number M and the allocation number N received from the external device.
